(19) United States
(12) Patent Application Publication
(10) Pub. No.: US 2011/0016388 A1
(43) Pub. Date: Jan. 20, 2011

(54) METHOD AND SYSTEM FOR EMBEDDING COVERT DATA IN A TEXT DOCUMENT USING SPACE ENCODING

(76) Inventors: Weng Sing Tang, Singapore (SG); Pern Chern Lee, Singapore (SG)

Correspondence Address: JACOBSON HOLMAN PLLC, 400 SEVENTH STREET N.W., SUITE 600, WASHINGTON, DC, 20004, US

(21) Appl. No.: 12/933,211

(22) PCT Filed: Mar. 17, 2009
(86) PCT No.: PCT/SG2009/000091

§ 371 Date: Sep. 17, 2010

(30) Foreign Application Priority Data
Mar. 18, 2008 (SG) 200802187-5

(51) Int. Cl. G06F 17/21

(52) U.S. Cl. 715/256

(57) ABSTRACT

A method and system for embedding covert data in a text document using space encoding. The space encoding changes the inter-word spacing and/or inter-character spacing within a text row to a particular format such that the data is essentially visually hidden in the text document.

### FIELD OF THE INVENTION

The invention is generally related to a method and system for embedding data covertly in a text document using space encoding.

### BACKGROUND

Digital watermarking is a well researched area in the signal processing community. Many techniques been devised to hide information covertly in text and image documents. Hiding data is commonly termed “steganography” in the cryptography community. Steganography for text and image documents differs greatly since modifying pixels in an image has much less visual effect than modifying pixels in text. Therefore, existing steganography techniques for image documents are not directly applicable to text documents.

Conventional methods for data hiding in text documents include dot encoding, space modulation (line shift coding, word shift coding), luminance modulation, halftone quantization, component manipulation and syntactic methods.

Conventional methods each have their own advantages and disadvantages. For example, dot encoding has high data hiding capacity but is typically vulnerable to printing and scanning of the text document because noise is introduced and interferes with decoding the dots. On the other hand, syntactic methods are resilient to printing and scanning but have low data capacity and are not self-verifiable.

There is an increasing need to prevent unauthorized disclosure of important information in text documents, especially in this knowledge-based era. There is also a need to discourage improper information disclosure by putting a track and trace mechanism in a printed text document. In case of information leakage, the source of leakage (person who printed the document) can be identified. There is also a need for data hiding with high capacity that is resilient to printing and scanning, accommodates a wide variety of text documents with little or no restrictions, and is self-verifiable.

### SUMMARY

An aspect of the invention is a method for embedding covert data in a text document, the method comprising providing the document having first and second characters; determining a horizontal space between the characters; altering the space to produce an altered space with a predetermined horizontal distance between the characters, wherein the altered space represents the embedded covert data; and formatting the document to produce a formatted document based on the altered space.

An aspect of the invention is a system for embedding covert data in a text document, the system comprising a data encoding processing device that receives the document having first and second characters, wherein the device includes a memory and a processor; the memory stores the document and a predetermined horizontal distance; and the processor determines a horizontal space between the characters, alters the space to produce an altered space with the predetermined horizontal distance between the characters, and formats the document to produce a formatted document based on the altered space, thereby embedding the embedded covert data in the document based on the altered space.

An aspect of the invention is a computer program product comprising a computer readable medium having computer program code means which, when loaded on a computer, makes the computer perform a method for embedding covert data in a text document, the method comprising providing the document having first and second characters; determining a horizontal space between the characters; altering the space to produce an altered space with a predetermined horizontal distance between the characters, wherein the altered space represents the embedded covert data; and formatting the document to produce a formatted document based on the altered space.

An aspect of the invention is a computer readable medium having a program recorded which, when loaded on a computer, makes the computer perform a method for embedding covert data in a text document, the method comprising providing the document having first and second characters; determining a horizontal space between the characters; altering the space to produce an altered space with a predetermined horizontal distance between the characters, wherein the altered space represents the embedded covert data; and formatting the document to produce a formatted document based on the altered space.

In embodiments, the document has multiple characters that include the first and second characters, and a space between each pair of the multiple characters that are horizontally adjacent to one another is altered to represent the embedded covert data. The document may have multiple characters that include the first and second characters, and a space between selected pairs of the multiple characters that are horizontally adjacent to one another is altered to represent the embedded covert data. The document may have multiple characters that include the first and second characters that form words, and a space between the words that are horizontally adjacent to one another is altered to represent the embedded covert data. The first character may haves a left character relative to the second character, the second character is a right character relative to the first character, and the space is determined by a horizontal distance between a right-most point of the left character and a left-most point of the right character. The characters may be formed along a straight horizontal line, or along a curved horizontal line. The method may further comprise decoding the formatted document to reveal the embedded covert data based on the altered space. The embedded covert data may be a user name, a global identifier, or the like. The altered space may represent a binary sequence, and the binary sequence is two bits, or the like. The space may be an inter-character space within a word, and the space is an inter-word space between horizontally adjacent words. The space may be determined in pixels, and the altered space may be expressed in pixels. The space and the altered space may differ in horizontal distance by a single pixel. The characters in the formatted document may be visually apparent to a user and a difference between the space and the altered space is essentially visually hidden from the user. The document and the formatted document the characters may be visually apparent to a user and a difference between the document and the formatted document is essentially visually hidden to the user.

### BRIEF DESCRIPTION OF THE DRAWINGS

In order that embodiments of the invention may be fully and more clearly understood by way of non-limitative examples, the following description is taken in conjunction with the accompanying drawings in which like reference numerals designate similar or corresponding elements, regions and portions, and in which:

FIG. 1 shows a system in accordance with an embodiment of the invention;

FIG. 2 shows a flow chart of a method of data hiding in a text document and data extracting from the text document that includes encoding and decoding the data in accordance with an embodiment of the invention;

FIGS. 3A and 3B show inter-word spacing (FIG. 3A) and inter-character spacing (FIG. 3B) of original text in accordance with an embodiment of the invention;

FIG. 4 shows altered inter-word spacing by changing the inter-word spacing of the text in FIG. 3A in accordance with an embodiment of the invention;

FIG. 5 shows altered inter-word spacing by embedding a binary sequence into the text in accordance with an embodiment of the invention;

FIG. 6 shows a table of different encoding for different numbers of inter-space elements in accordance with an embodiment of the invention;

FIG. 7 shows a comparison table of conventional data hiding techniques in a text document with an embodiment of the invention; and

FIG. 8A-C shows a Table A that lists all the Y-coordinates and width of detected lines (FIG. 8A), the vertical signature of a typical scanned text document at 300 dpi (FIG. 8B), and the location of the extracted lines from the same document (FIG. 8C) in accordance with an embodiment of the invention.

### DETAILED DESCRIPTION

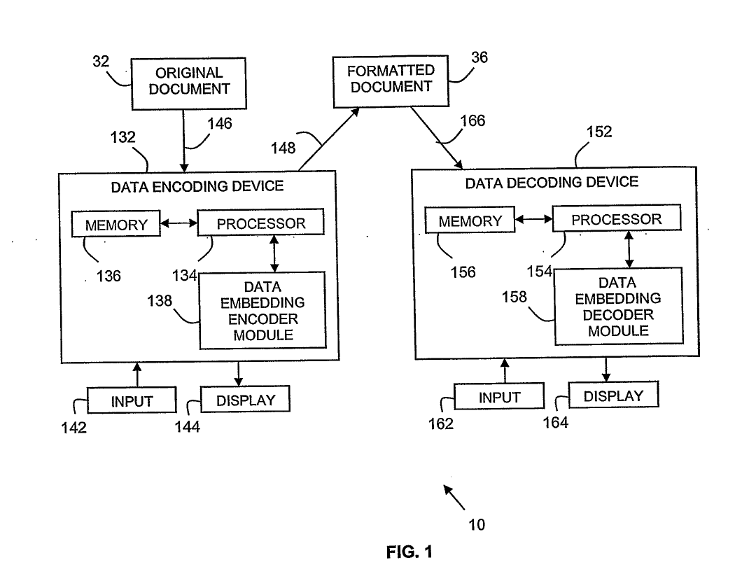

FIG. 1 shows a system 10 in accordance with an embodiment of the invention for embedding covert data in and extracting the covert data from a text document. An original document 32 is embedded with covert hidden data by a data encoding processing device 132 which is a computer comprising a processor 134, memory 136 and data embedding encoder module 138 for encoding the covert data in the text document 32. A user may input and view the data with an input 152 and display 154. Once encoded and embedded in the formatted document 36, the formatted document 36 is transmitted to a data decoding processing device 152 to decode the embedded covert data in the formatted document 36. The data decoding processing device 152 is a computer comprising a processor 154, memory 156 and data embedding decoder module 158 for decoding the embedded covert data in the formatted document 36. A user may input and view the data with an input 162 and display 164.

Although shown as two separate computers, it will be appreciated that the data embedding encoder and decoder modules 138 and 158 may reside on the same computer. A transmission link 146 for transmitting the original document 32 to the data encoding processing device 132, and transmission links 148 and 166 for transmitting the formatted document 36 from the data encoding processing device 132 to the data decoding processing device 152, may be public or private networks, the Internet and the like. The documents 32 and 36 may be hardcopies and/or electronic versions. If the documents 32 and 36 are in hardcopy form, the documents 32 and 36 may be converted into electronic format by scanning and the like.

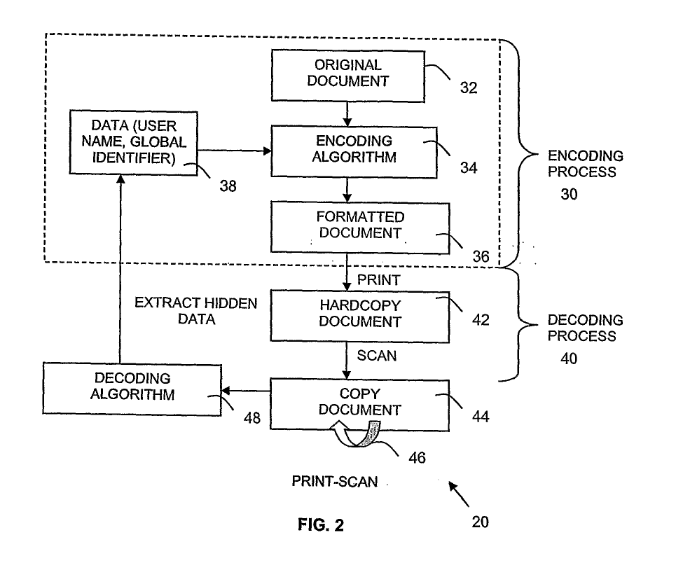

FIG. 2 shows a flow chart 20 of a method of data hiding and data extracting in a text document in accordance with an embodiment of the invention that includes an encoding process 30 and a decoding process 40. The original document 32 is converted by an encoding algorithm 34 into the formatted document 36 in the encoding process 30. The data 38 to be hidden may be a user name, global identifier and the like. In the decoding process 40, the formatted document 36 is printed, a hardcopy document 42 is produced and scanned, and a copy document 44 is print-scanned 46. A decoding algorithm 48 extracts the hidden data from the copy document 44. It will be appreciated that the format may be any format as encoding is independent of the document format. Additionally, the method may be applied to any language as long as there is a “space” that exists between “words”.

### Encoding

In this particular context, for a formatted text document, the term “inter-word space” refers to the horizontal space between horizontally adjacent words in a text row. For example, the horizontal space between the right-most point of the left character of the left word and the left-most point of the adjacent right character of the right word. Similarly, the horizontal space between horizontally adjacent characters is the right-most point of the left character and left-most point of the horizontally adjacent right character. The term “inter-character space” of a word refers to the horizontal space between horizontally adjacent characters in that word. Lengths of inter-word and inter-character spaces may be determined and expressed in pixels.

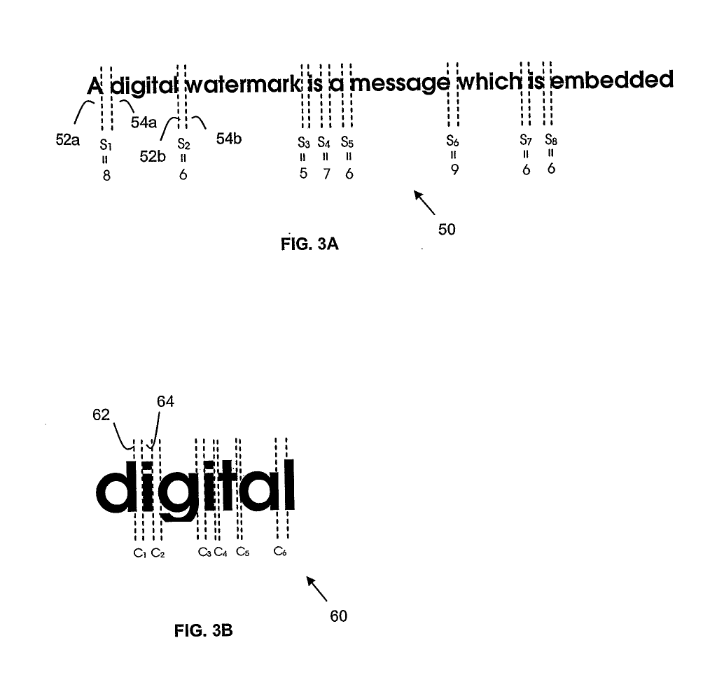

FIGS. 3A and 3B show examples of inter-word spacing 50 and inter-character spacing 60, respectively, in a text row. Specifically, FIG. 3A shows an example of inter-word spacings 52a, 52b, 54a, 54b in original text, and FIG. 3B shows an example of inter-character spacing 62 and 64 in a word. It will be appreciated that the procedure may be conducted to alter any two characters, not just text as this is provided for illustration.

The length L of inter-word spaces of an original text row is calculated by:

$$L = {{S}_{i}}_{i = 1}^{k}$$

Where for a given i, sᵢ represent a particular inter-word space, i is a reference number to indicate which space is referenced, and k represents the total number of inter-word space in a text row concerned. In FIG. 3A, L=8+6+5+7+6+9+6+6=53.

In one particular embodiment, the inter-word space S=[s₁, s₂, s₃ . . . s₇, s₈] is changed into S′=[s₁′, s₂′, s₃′ . . . s₇′, s₈′] by modifying the inter-character space [c₁, c₂ . . . cₙ] of each word in the text row. For each word, the inter-character space, is reduced by 1 pixel if cᵢ>2 pixels. Hence, the overall inter-word space is increased such that for each sᵢ, sᵢ′ sᵢ. By increasing the values of sᵢ′, the total length of L′ of the new inter-word space satisfies the condition: L′ L.

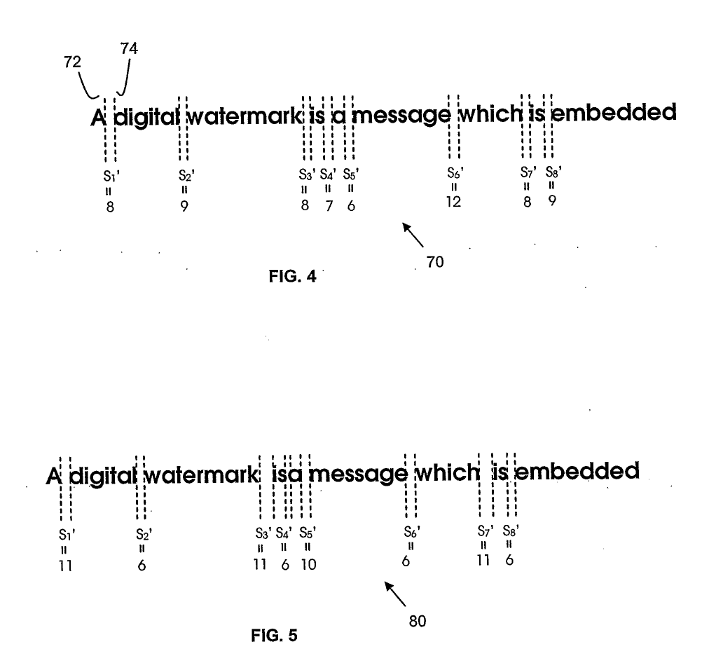

FIG. 4 shows modification 70 of inter-word spacing by changing inter-character spacing 72, 74 in accordance with an embodiment of the invention. In this example, the inter-word spacing is provided by changing the inter-word spacing in FIG. 3A. In FIG. 4, L′=8+9+8+7+6+12+8+9=67.

For convenience, the function Sign ([s₁, s₂ . . . sₙ]) is defined by:

Let sₘᵢₙ=floor integer(average of the ε smallest value in [s₁, s₂ . . . sₙ]).

Sign([s₁, s₂ . . . sₙ])=g₁|g₂| . . . gₙ

where
gᵢ=+ if sᵢ>sₘᵢₙ
gᵢ=− if sᵢ sₘᵢₙ

The value ε is greater than or equal to the number of “−” gᵢ selected.

The data to be hidden is represented in binary form as a sequence of “1”s and “0”s.

In one particular embodiment, the inter-word space S″=[s₁″, s₂″, s₃″ . . . s₇″, s₈″] such that:

L″=s₁″+s₂″+s₃″ . . . +s₇″+s₈″

L′=s₁′+s₂′+s₃′ . . . +s₇′+s₈′

L′=L″

[s₁″, s₂″, s₃″ . . . s₇″, s₈″] satisfies the following condition:

To embed bits ‘00’: Sign(S″)=+|−|+|−|+|−|+|−
To embed bits ‘01’: Sign(S″)=−|−|+|+|−|−|+|+
To embed bits ‘10’: Sign(S″)=+|+|−|−|−|−|+|+
To embed bits ‘11’: Sign(S″)=−|−|+|+|+|+|−|−

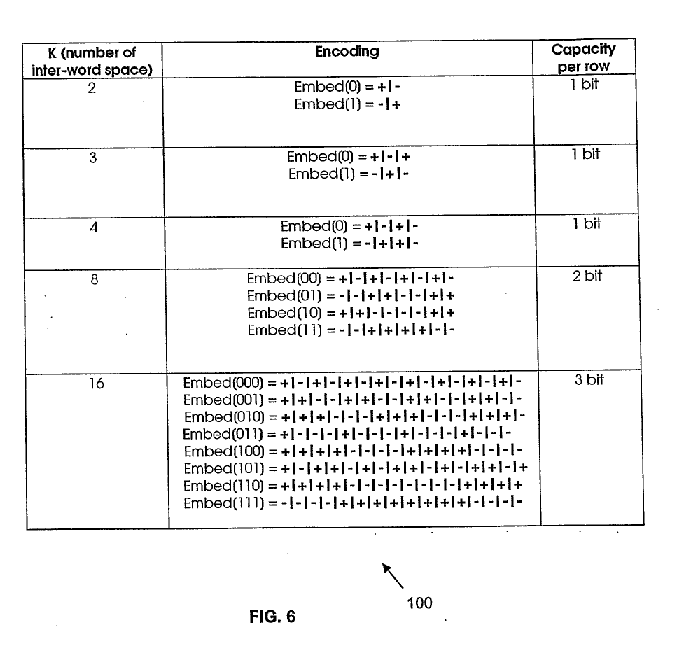

FIG. 5 shows inter-word spacing by embedding a binary sequence into the text row in accordance with an embodiment of the invention. In this example, inter-word spacing 80 is embedded with a two bit binary sequence. The robustness against printing and scanning depends on differences in pixel values between each “+” sᵢ and sₘᵢₙ. Furthermore, different encoding schemes can be used based on the number of words, for example the number of inter-word spaces k, in each text row.

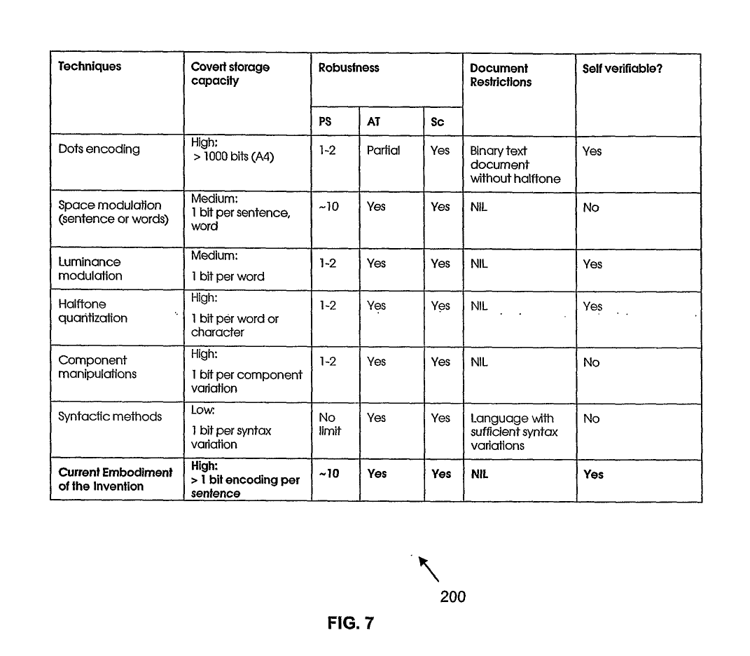

FIG. 6 shows a table 100 of different encoding for different numbers of inter-space elements in accordance with an embodiment of the invention.

In order to encode in text with different fontsize and therefore different lengths of inter-word spacing, a scaling invariant method can be used. Let S=[s₁, s₂, s₃ . . . s₇, s₈] denotes a particular inter-word space and F=[f₁, f₂, f₃ . . . f₇, f₈] where each fᵢ denotes the fontsize of the last character in the word before sᵢ.

First, S is normalized to form a scale invariant unit, V, by dividing each sᵢ by fᵢ:

V=[v₁, v₂, v₃ . . . v₇, v₈] where vᵢ=sᵢ/fᵢ

After this, the same encoding method as described in an embodiment of the invention may be used over V.

### Decoding

Printing, scanning and copying may introduce geometric distortions, which may make data extraction difficult. A variety of techniques to reduce these geometric distortions is well-known and continue to be developed. The invention is not limited to any of these techniques.

The system 10 decodes the embedded covert data in the formatted document 36. For example, using a horizontal profile of the text document as a reference point, the inter-word spaces are extracted. For each text row with an inter-word space, the Sign function described above computes the embedded “+” and “−”. With this and the encoding scheme, the hidden data is identified. In addition, the reference point can be determined using a vertical profile, horizontal profile and the like. Thus, it is not necessary to compare the original document 32 with the formatted document 36 having the embedded covert data in order to extract the embedded covert data from the formatted document 36. Other ways of determining profile or reference point is possible, for example, another way is to use optical character recognition (OCR) to determine bounding box for words and then calculate the inter-word space to get the space profile.

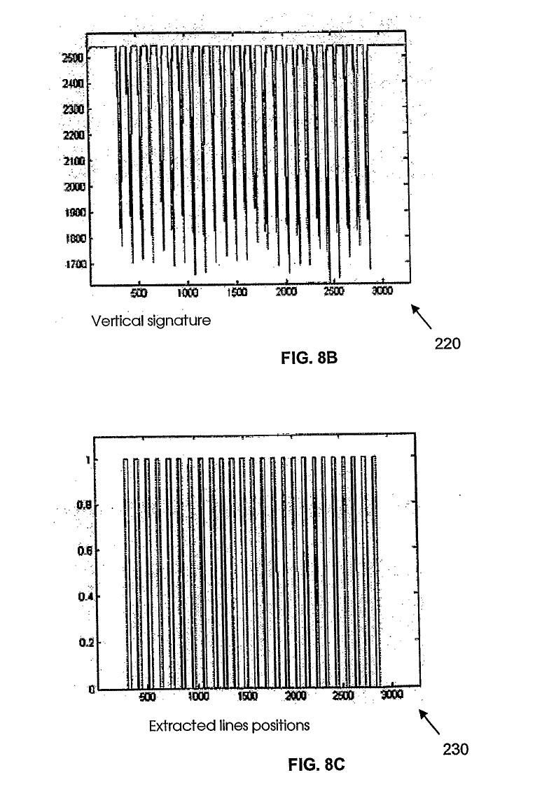

In an embodiment, the process for determining profile is:
1) Scan the physical document at reasonable quality and resolution. The higher the resolution the more accurate the space profile is.
2) Convert image into a binary image by properly thresholding it. The value of the threshold can be determined from the document image histogram, which is bimodal. Assign 1 to any value higher than the threshold and 0 otherwise.
3) Extract the lines of the scanned document by computing the vertical signature v(i) of the image l (i, j):

$$v ( i ) = {\sum }_{j = 1}^{w} I ( i , j )$$

where W is the width of the image l(i, j). FIG. 8B shows the vertical signature 220 of a typical scanned text document at 300 dpi. FIG. 8C shows the location of the extracted lines 230 from the same document. FIG. 8A shows a Table A 210 that lists all the Y-coordinates and width of detected lines.
4) Detect and extract all the spaces between consecutive words. This can be achieved by computing the horizontal signature, h(i), of a small image strip S(i, j) around each line as follows:

$$h ( i ) = {\sum }_{i = 1}^{H} S ( i , j )$$

where H denotes the height of the strip S(i, j).

For encoding the data, preferably there is a minimum of two words in each text row, and the data capacity is proportional to the text information in the document since the robustness depends on the length of each sentence.

The invention is applicable to various text documents such as transcripts, diplomas, certificates and the like in the academic field; shares and bonds certificates, insurance policies, statements of account, letters of credit, legal forms and the like in the financial field; immigration visas, titles, financial instruments, contracts, licenses and permits, classified documents and the like in the government field; prescriptions, control chain management, medical forms, vital records, printed patient information and the like in the health care field; schematics, cross-border trade documents, internal memos, business plans, proposals, designs and the like in the business field; tickets, postage stamps, manuals and books, coupons, gift certificates, receipts, and the like in the consumer field; and many other applications and fields.

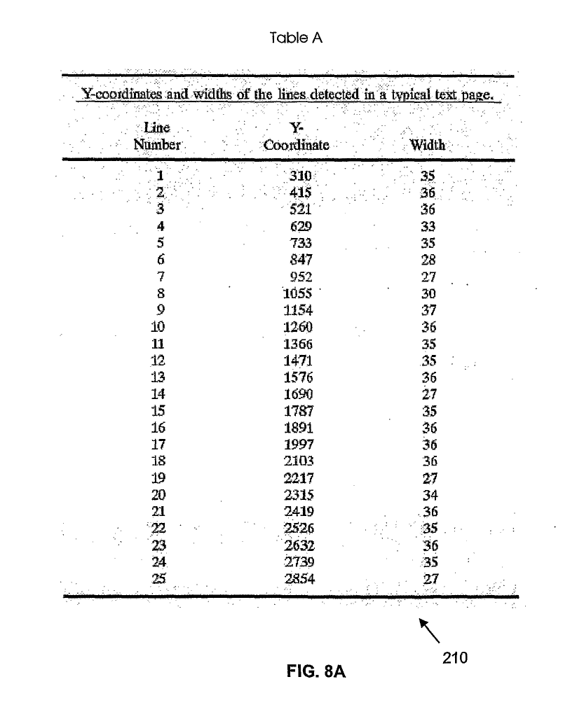

FIG. 7 shows a comparison table 200 of the storage characteristics, robustness, text document limitations and security for conventional data hiding techniques in a text document with an embodiment of the invention.

Thus, a method and system for embedding covert data in a text document using space encoding is disclosed where the space encoding changes the inter-word spacing and/or inter-character spacing within a text row to a particular format such that the data is essentially visually hidden in the text document.

While embodiments of the invention have been described and illustrated, it will be understood by those skilled in the technology concerned that many variations or modifications in details of design or construction may be made without departing from the invention.

1. A method for embedding covert data in a text document, the method comprising:
providing the document having first and second characters;
determining a horizontal space between the characters;
altering the space to produce an altered space between the characters, wherein the altered space represents the embedded covert data; and
formatting the document to produce a formatted document based on the altered space.

2. A method as claimed in claim 1, wherein the document has multiple characters that include the first and second characters, and a space between each pair of the multiple characters that are horizontally adjacent to one another is altered to represent the embedded covert data.

3. A method as claimed in claim 1, wherein the document has multiple characters that include the first and second characters, and a space between selected pairs of the multiple characters that are horizontally adjacent to one another is altered to represent the embedded covert data.

4. A method as claimed in claim 1, wherein the document has multiple characters that include the first and second characters that form words, and a space between the words that are horizontally adjacent to one another is altered to represent the embedded covert data.

5. A method as claimed in claim 1, wherein the first character is a left character relative to the second character, the second character is a right character relative to the first character, and the space is determined by a horizontal distance between a right-most point of the left character and a left-most point of the right character.

6. A method as claimed in claim 1, wherein the characters are formed along a straight horizontal line.

7. A method as claimed in claim 1, wherein the characters are formed along a curved horizontal line.

8. A method as claimed in claim 1, further comprising decoding the formatted document to reveal the embedded covert data based on the altered space.

9. A method as claimed in claim 1, wherein the embedded covert data is a user name.

10. A method as claimed in claim 1, wherein the embedded covert data is a global identifier.

11. A method as claimed in claim 1, wherein the altered space represents a binary sequence.

12. (canceled)

13. A method as claimed in claim 1, wherein the space is an inter-character space within a word.

14. (canceled)

15. A method as claimed in claim 1, wherein the space is determined in pixels.

16. A method as claimed in claim 1, wherein the altered space is expressed in pixels.

17. A method as claimed in claim 1, wherein the space is determined in pixels and the altered space is expressed in pixels.

18. A method as claimed in claim 1, wherein the space and the altered space differ in horizontal distance by a single pixel.

19. A method as claimed in claim 1, wherein the characters in the formatted document are visually apparent to a user and a difference between the space and the altered space is essentially visually hidden from the user.

20. A method as claimed in claim 1, wherein in the document and the formatted document the characters are visually apparent to a user and a difference between the document and the formatted document is essentially visually hidden to the user.

21. A system for embedding covert data in a text document, the system comprising:
a data encoding processing device that receives the document having first and second characters, wherein the device includes a memory and a processor;
the memory stores the document and a predetermined horizontal distance; and
the processor determines a horizontal space between the characters, alters the space to produce an altered space with the predetermined horizontal distance between the characters, and formats the document to produce a formatted document based on the altered space, thereby embedding the embedded covert data in the document based on the altered space.

22-40. (canceled)

41. A computer program product comprising:
a computer readable medium having computer program code means which, when loaded on a computer, makes the computer perform a method for embedding covert data in a text document, the method comprising:
providing the document having first and second characters;
determining a horizontal space between the characters;
altering the space to produce an altered space with a predetermined horizontal distance between the characters, wherein the altered space represents the embedded covert data; and
formatting the document to produce a formatted document based on the altered space.

42. A computer readable medium having a program recorded which, when loaded on a computer, makes the computer perform a method for embedding covert data in a text document, the method comprising:
providing the document having first and second characters;
determining a horizontal space between the characters;
altering the space to produce an altered space with a predetermined horizontal distance between the characters, wherein the altered space represents the embedded covert data; and
formatting the document to produce a formatted document based on the altered space.

43. A method as claimed in claim 1, wherein the altered space has a predetermined horizontal distance between the characters.

44. A method as claimed in claim 1, wherein the altered space bears a predetermined relationship to a chosen reference space.
